(19) United States
(12) Patent Application Publication
(10) Pub. No.: US 2014/0312097 A1
(43) Pub. Date: Oct. 23, 2014

(54) WIRE CONNECTION METHOD AND WIRE CONNECTION DEVICE

(71) Applicant: Yazaki Corporation, Tokyo (JP)

(72) Inventors: Shinji MIYAZATO, Makinohara-shi (JP); Ayako SHIMIZU, Makinohara-shi (JP)

(73) Assignee: Yazaki Corporation, Tokyo (JP)

(21) Appl. No.: 14/250,906

(22) Filed: Apr. 11, 2014

(30) Foreign Application Priority Data
Apr. 17, 2013 (JP) 2013-086198

(51) Int. Cl. H01R 43/02; H01R 43/00

(52) U.S. Cl. CPC H01R 43/0207; H01R 43/00
USPC 228/111; 228/1.1

(57) ABSTRACT

In connecting a conductor consisting of a plurality of core lines of an electric wire to a terminal, it is performed to make the core lines, which are adjacent to each other at a peripheral part in a vicinity of an end of the conductor, into contact with each other adhesively and join the end of the conductor to the terminal by pressurized ultrasonic oscillation using a compression-and-vibration horn. In making the adjacent core lines in contact with each other, a metal sleeve may be fitted in an annular manner in the vicinity of the end or the peripheral part of the conductor may be subjected to welding, alternatively.

### TECHNICAL FIELD

The present invention relates to a method and device for connecting a wire applied to various kinds of instruments to a connected part, such as a connection terminal.

### BACKGROUND ART

For a method of electrically connecting an electrical wire, such as twisted wire consisting of a plurality of core lines collected up, to a connected part, such as a connection terminal, there is a known method of connecting an end of a conductor exposed out from a jacket of the wire (e.g. exposed conductor obtained by peeling an insulation jacket of the wire) to a given connecting position defined in the connected part by means of pressurized ultrasonic bonding. For a conductor's end, which has been previously compressed so as to accord with a configuration of the connected part in the connecting position by press molding, it is required to ensure the reliability of electrical connection between the conductor's end and the connected part of the connection terminal (i.e. improved joint strength or short-circuit proof) by suppressing an occurrence of burrs at pressurized ultrasonic bonding.

### CITATION LIST

### Patent Literature

PTL 1: JP 2006-172927 A

PTL 2: JP 2004-095293 A

PTL 3: JP 2009-277445 A

### SUMMARY OF INVENTION

Under the above-mentioned circumstances, an object of the present invention is to enhance tightness of respective core lines at an end of the conductor thereby preventing the conductor's end from scattering in all directions and to suppress an occurrence of burrs at pressurized ultrasonic bonding thereby enhancing the reliability of electrical connection between the end of the conductor and the connected part.

A wire connection method according to a first aspect of the present invention is a method of connecting a conductor consisting of a plurality of core lines of an electric wire to a connected part, the method includes: making the core lines, which are adjacent to each other at a peripheral part in a vicinity of an end of the conductor, into contact with each other adhesively; and joining the end of the conductor to the connected part by pressurized ultrasonic oscillation.

Since the adjacent core lines at the peripheral part in the vicinity of the end of the conductor are connected with each other, it is possible to suppress scattering of the core lines at the end of the conductor when joining the end of the conductor to the connected part by pressurized ultrasonic oscillation.

The adjacent core lines may be contacted with each other adhesively by fitting a metal sleeve in an annular manner in the vicinity of the conductor's end. At the peripheral part in the vicinity of the conductor's end surrounded with the metal sleeve, consequently, the core lines are attached firmly to each other, so that the contact resistance among the core lines is reduced. Additionally, due to the surrounding arrangement of the metal sleeve, the cross-sectional area of the vicinity of the end of the conductor is increased to enhance the joint strength between the relevant conductor and the connected part, so that the contact resistance between the conductor and the connected part is reduced.

Alternatively, the peripheral part in the vicinity of the end may be welded to adhesively join the adjacent core lines to each other. Consequently, the core lines are joined to each other by welding, so that the contact resistance among the core lines is reduced.

A wire connection device according to a second aspect of the present invention is a connection device for connecting a conductor consisting of a plurality of core lines of an electric wire to a connected part, the device includes: a welding unit configured to make the core lines, which are adjacent to each other at a peripheral part in a vicinity of an end of the conductor, into contact with each other by welding; and a compression-and-vibration horn configured to join the end of the conductor having the core lines in contact with each other to the connected part by pressurized ultrasonic oscillation.

In accordance with the first and second aspects of the present invention, it is possible to provide a wire connection method and a wire connection device, which can suppress an occurrence of burrs at the end of the conductor thereby enhancing the reliability of electrical connection between the end of the conductor and the connected part.

### BRIEF DESCRIPTION OF DRAWINGS

FIGS. 1A to 1F are views explaining a connecting process of a conductor of an electric wire according to a first embodiment.

FIG. 2 is a side view illustrating a condition where an end of the conductor of the electric wire is crimped in the first embodiment.

FIGS. 3A to 3F are views explaining a connecting process of the conductor of the electric wire according to a second embodiment.

FIG. 4A is a perspective view illustrating a crimped condition of a conductor of an electric wire according to a conventional example, FIG. 4B is a perspective view illustrating a process of connecting an end of the conductor of the electric wire to a terminal according to the conventional example, and FIG. 4C is a perspective view illustrating a condition of the end of the conductor according to the conventional example.

### DESCRIPTION OF EMBODIMENTS

Embodiments of the present invention will be described with reference to drawings, below.

### First Embodiment

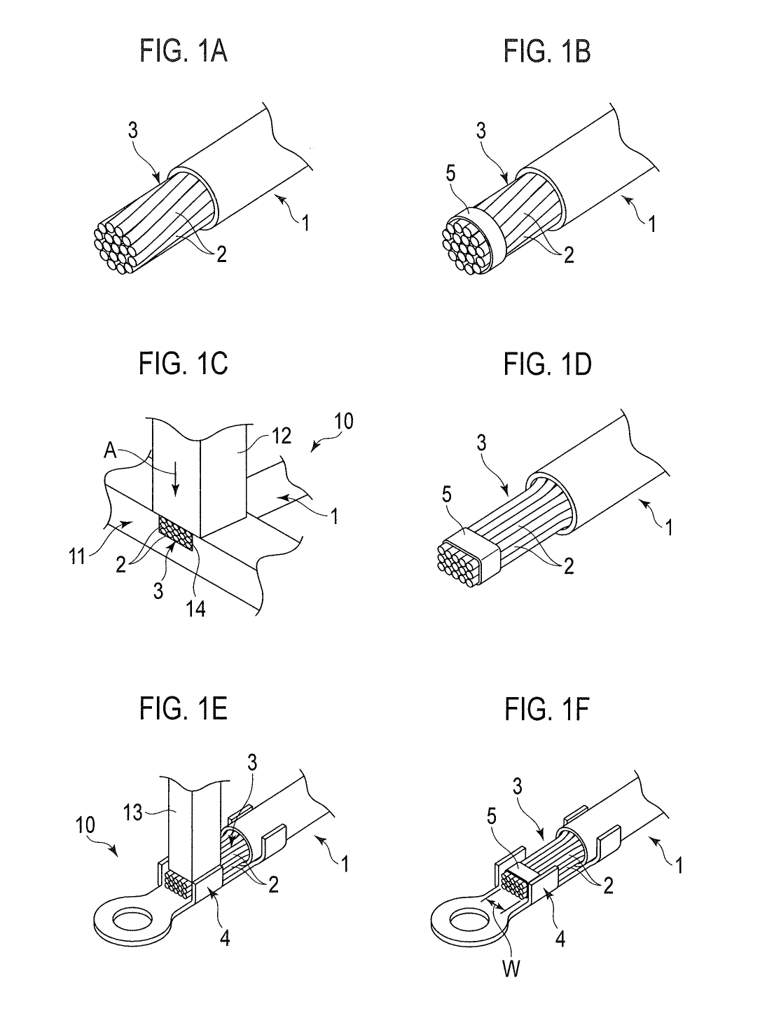

A first embodiment will be described with reference to FIGS. 1A to 1F.

For an electric wire 1 having an conductor 3 consisting of a plurality of core lines 2, a wire connection method according to the first embodiment is a method for connecting the conductor 3 to a terminal (i.e. a connected part) 4, which includes the steps of making the core lines 2, which are adjacent to each other at a peripheral part in the vicinity of an end of the conductor 3, into contact with each other adhesively, and joining the conductor 3 to the terminal 4 by applying pressurized ultrasonic oscillation on the end of the conductor. In the first embodiment, the adjacent core lines 2 are adhesively connected to each other since the conductor is surrounded with a metal sleeve 5 in the vicinity of the conductor's end.

Next, a wire connection device 10 for carrying out the wire connection method according to the first embodiment will be described.

The wire connection device 10 is a device for connecting the conductor 3 of the wire 1 to the terminal 4. The wire connection device 10 includes a press die 11 which restricts the end of the conductor 3 to a width according with a joint width W of the terminal 4 under condition that the adjacent core lines 2 are adhesively connected to each other since the conductor 3 is surrounded with the metal sleeve 5 at the peripheral part in the vicinity of the end of the conductor 3, a press molding machine 12 which fixes the vicinity of the end of the conductor 3 having its width restricted, by applying pressure in the direction of thickness of the conductor's end, and a compression-and-vibration horn 13 which joins the vicinity of the end of the conductor 3, which serves as a crimp part, to the terminal 4 by pressurized ultrasonic oscillation.

The metal sleeve 5 is made of the same kind of material as material constituting the conductor 3 and molded in the form of a sleeve. An inner diameter of the meal sleeve 5 is defined so as to correspond to a diameter of the conductor 3.

The press die 11 is formed with a conductor-width restricting groove 14, as illustrated in FIG. 1C. A width of the conductor-width restricting groove 14 is defined so as to be equivalent to the joint width W of the terminal 4, as illustrated in FIG. 1F. Since the end of the conductor 3 is fittingly inserted into the conductor-width restricting groove 14, the width of the end of the conductor 3 is restrained so as to accord with the joint width W of the terminal 4.

The press molding machine 12 pressurizes the vicinity of the end of the conductor 3 of the wire 1, which has its width restricted by the press die 11, in the direction of thickness (i.e. a direction illustrated with arrow A) to press the above vicinity into shape in the form of a predetermined flat plate.

Under condition that the press-molded end of the conductor 3 is fittingly inserted into a contacted part of the terminal 4 mounted on a molding die (not illustrated) as illustrated in FIG. 1E, the compression-and-vibration horn 13 ultrasonically joins the end of the conductor 3 to the contacted part under pressure. Note, in the molding die, its portion in contact with the terminal 4 is shaped so as to correspond to the shape of the terminal 4. Thus, high adhesiveness between the conductor 3 and the terminal 4 is ensured to establish preferable joint property therebetween.

Next, the connecting process of the wire 1 to the terminal 4 in the first embodiment will be described.

First, the conductor 3 is exposed out of a insulation jacket of the wire 1 by peeling it, as illustrated in FIG. 1A. Next, as illustrated in FIG. 1B, since the metal sleeve 5 is fitted around the peripheral part of the vicinity of the end of the conductor 3 exposed from the insulation jacket of the wire 1, the adjacent core lines 2 in the relevant peripheral part are brought into mutually-adhesive condition.

Next, as illustrated in FIG. 1C, the end of the conductor 3 around which the metal sleeve 5 is fitted is fittingly inserted into the conductor-width restricting groove 14 of the press die 11 to restrict the conductor's end into a width corresponding to the joint width W of the terminal 4. In this state, the press molding machine 12 pressurizes the end of the conductor 3 in the direction of thickness (i.e. a direction illustrated with arrow A). Then, the end of the conductor 3 is molded in the form of a predetermined flat plate, as illustrated in FIG. 1E.

Then, the press-molded end of the conductor 3 is fittingly inserted into the connected part of the terminal 4 and ultrasonically oscillated under pressure by the compression-and-vibration horn 13, as illustrated in FIG. 1E. Consequently, as illustrated in FIG. 1F, the end of the conductor 3 is joined to the connected part of the terminal 4 while the width of the end is being restricted by the width of the connected part of the terminal 4. In this way, the conductor 3 of the wire 1 is connected to the terminal 4.

The effect of the first embodiment will be described below.

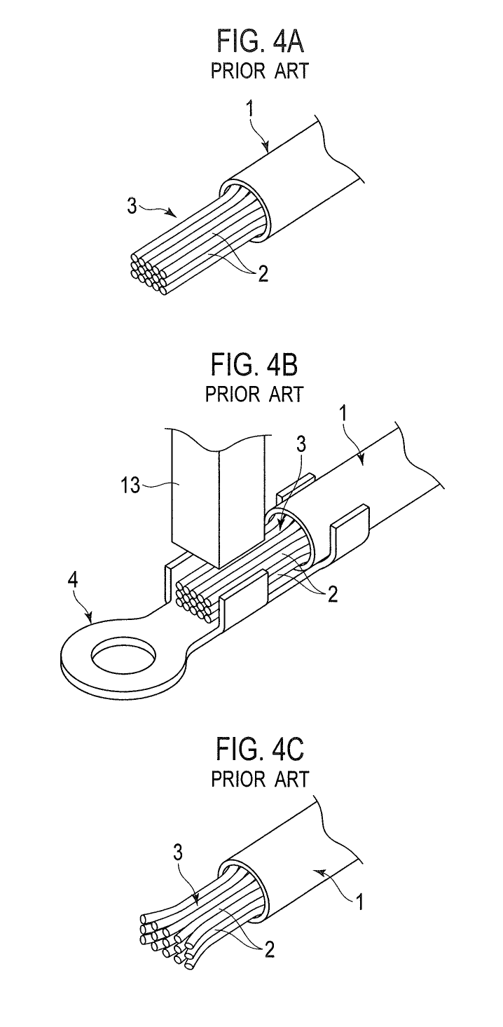

In a conventional example related to the method of connecting a conductor of a wire to a connection terminal, as illustrated in FIGS. 4A and 4B, there has been adopted a method including the steps of: press molding an end of the conductor 3, which has been exposed out of the wire 1, into a plate so as to accord with the width W of the connected part of the connection terminal 4; next inserting the molded end into the connected part fittingly; and connecting the inserted end to the terminal 4 by pressurized ultrasonic oscillation using the compression-and-vibration horn 13 (see PTL 1 to 3).

In the method of the conventional example, since the end of the conductor 3 is press-molded into a plate before the connecting operation using pressurized ultrasonic oscillation, the breaking of the conductor 3 is prevented at the pressurized ultrasonic bonding of the conductor 3.

However, in the case that the press-molded end of the conductor 3 is supplied to the ultrasonic bonding, there is a possibility that the core lines 3 at the end of the conductor 3 straggle out, as illustrated in FIG. 4C, to cause an occurrence of burrs at the end of the conductor 3. Due to such an occurrence of burrs, there is fear that the joint strength between the conductor 3 and the connection terminal 4 is reduced as well as electrical short circuit is caused due to falling of burrs.

In the first embodiment, therefore, the adjacent core lines 2 at the peripheral part are temporarily connected to each other since the peripheral part of the conductor 3 is surrounded, in the vicinity of its end, with the metal sleeve 5. Then, the end of the conductor 3 is crimped under this condition and thereafter, the conductor's end is joined to the terminal 4 by the pressurized ultrasonic oscillation using the compression-and-vibration horn 13.

As the adjacent core lines 2 at the peripheral part in the vicinity of the end of the conductor 3 are adhesively connected to each other previously, it is possible to suppress scattering of the core lines 2 at the end of the conductor 3 despite that the end of the conductor 3 is supplied for the pressurized ultrasonic joining process.

Again, since the metal sleeve 5 is fitted in an annular manner in the vicinity of the end of the conductor 3, the core lines 2 are attached firmly to each other at the peripheral part of the vicinity of the end of the conductor 3 while reducing the contact resistance of the core lines 2, so that the electrical performance of the conductor 3 is improved.

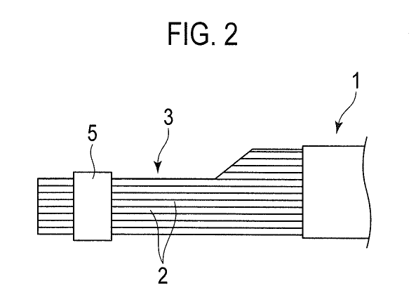

Further, as the metal sleeve 5 is fitted in the annular manner, the cross-sectional area of the vicinity of the end of the conductor 3 is increased in comparison with that of the conductor's end supplied for the conventional wire connection method, as illustrated in FIG. 2. As a result, as the joint strength between the conductor 3 and the terminal 4 is increased while suppressing the contact resistance between the conductor 3 and the terminal 4, the electrical connecting performance between the conductor 3 and the terminal 4 is improved.

As mentioned above, since the crimp part of the conductor 3 does not scatter, the occurrence of burrs is suppressed at the end of the conductor 3 despite that the end of the conductor 3 is joined to the terminal 4 through the pressurized ultrasonic oscillation, so that the joint strength between the conductor 3 and the terminal 4 is stabilized to enable the prevention of an occurrence of electrical short. Thus, the quality of the terminal 4 having the conductor 3 connected thereto is stabilized to make a post-process inspection operation unnecessary, so that the manufacturing cost can be saved.

### Second Embodiment

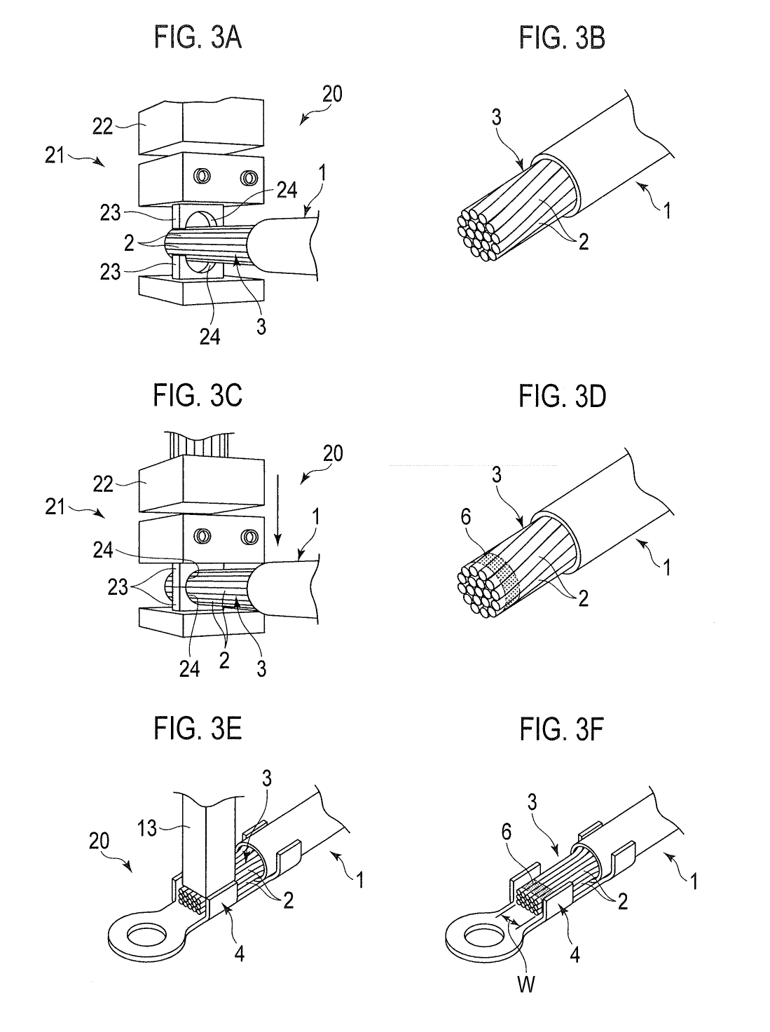

A second embodiment will be described with reference to FIGS. 3A to 3F.

For the electric wire 1 having the conductor 3 consisting of the plurality of core lines 2, a wire connection method according to the second embodiment is a method for connecting the conductor 3 to the terminal 4. In this method, it is performed to make the core lines 2, which are adjacent to each other at the peripheral part in the vicinity of an end of the conductor 3, in contact with each other adhesively by welding and subsequently join the end of the conductor 3 to the terminal 4 by the pressurized ultrasonic oscillation.

A wire connection device 20 for performing the wire connection method according to the second embodiment will be described.

The wire connection device 20 is a device for connecting the conductor 3 of the wire 1 to the terminal 4. The wire connection device 20 includes a welding unit 21 which makes the core lines, which are adjacent to each other at a peripheral part in the vicinity of the end of the conductor 3, into contact with each other adhesively by welding, and a compression-and-vibration horn 13 which joins the end of the conductor 3, to which the core lines 2 are adhered, to the terminal 4 by the pressurized ultrasonic oscillations.

The welding unit 21 is a high-frequency induction pressure-welding type welding unit, and includes a pair of heating horns 23 for allowing the core lines 2 at the peripheral part of the conductor 3 to adhere to each other by high-frequency induction heating while subjecting to pressure from the compression horn 22. The heating horn 23 is formed with fitting-insertion grooves 24 into which the conductor 3 of the wire 1 is fittingly inserted. The diameter of the fitting-insertion grooves 24 is established so as to correspond to the diameter of the conductor 2.

Next, the connecting process of the wire 1 to the terminal 4 in the second embodiment will be described.

First, the conductor 3 is exposed out of the insulation jacket of the wire 1 by peeling it, as illustrated in FIG. 3B. Next, as illustrated in FIG. 3A, the vicinity of the end of the conductor 3 is fittingly inserted between the fitting-insertion grooves 24 of both heating horns 23. Next, as illustrated in FIG. 3C, the peripheral part in the vicinity of the end of the conductor 3 inserted into the fitting-insertion grooves 24 is induction-heated at high frequency by the heating horn 23 while being pressurized by the compression horn 22. Consequently, the core lines 2 are welded to each other at the peripheral part, as illustrated with a welded part 6 of FIG. 3D.

Then, the end of the conductor 3 where the core lines 2 adheres to each other at the peripheral part is fittingly inserted into the connected part of the terminal 4 and ultrasonically oscillated under pressure by the compression-and-vibration horn 13, as illustrated in FIG. 3E. Consequently, as illustrated in FIG. 3F, the end of the conductor 3 is joined to the connected part of the terminal 4 while the width of the end is being restricted by the width W of the connected part of the terminal 4. In this way, the conductor 3 of the wire 1 is connected to the terminal 4.

As the adjacent core lines 2 at the peripheral part in the vicinity of the end of the conductor 3 are temporarily connected to each other by previous welding, it is possible to suppress scattering of the core lines 2 at the end of the conductor 3 despite that the end of the conductor 3 is supplied for the pressurized ultrasonic joining process.

Particularly, as the core lines 2 are bonded to each other by welding and the contact resistance among the core lines 2 is reduced, the electrical performance of the conductor 3 is improved.

Additionally, as the conductor 3 is in crimping condition with the application of high-frequency induction pressure-welding method in the process of welding, the contact resistance among the core lines 2 is further reduced as well as an extra-crimping process becomes unnecessary.

As mentioned above, since the end of the conductor 3 does not scatter also in the second embodiment, the occurrence of burrs is suppressed at the end of the conductor 3 in spite of bonding of the end of the conductor 3 to the terminal 4 through pressurized ultrasonic oscillation, so that the joint strength between the conductor 3 and the terminal 4 is stabilized to enable the prevention of an occurrence of electrical short.

Thus, the quality of the terminal 4 having the conductor 3 connected thereto is stabilized to make a post-process inspection operation unnecessary, so that the manufacturing cost can be saved.

Especially, as the second embodiment does not require the crimping process, the number of processes of connecting the wire 1 to the terminal 4 is reduced to lead the reduction in management cost and installation cost about the connecting process of the wire 1.

What is claimed is:

1. A wire connection method for connecting a conductor consisting of a plurality of core lines of an electric wire to a connected part, comprising:
making the core lines, which are adjacent to each other at a peripheral part in a vicinity of an end of the conductor, into contact with each other adhesively; and
joining the end of the conductor to the connected part by pressurized ultrasonic oscillation.

2. The wire connection method according to claim 1, wherein
the step of making the adjacent core lines into contact with each other is accomplished by surrounding the vicinity of the end with a metal sleeve.

3. The wire connection method according to claim 1, wherein
the step of making the adjacent core lines into contact with each other is accomplished by welding the peripheral part of the conductor.

4. A wire connection device for connecting a conductor consisting of a plurality of core lines of an electric wire to a connected part, comprising:
a welding unit configured to make the core lines, which are adjacent to each other at a peripheral part in a vicinity of an end of the conductor, into contact with each other by welding; and
a compression-and-vibration horn configured to join the end of the conductor having the core lines in contact with each other to the connected part by pressurized ultrasonic oscillation.
